(19) United States
(12) Patent Application Publication
(10) Pub. No.: US 2004/0024089 A1
(43) Pub. Date: Feb. 5, 2004

(54) Use of epoxypolysiloxanes modified with oxyalkylene ether groups as additives for radiation-curing coatings

(76) Inventors: Stefan Busch, Bochum (DE); Sascha Oestreich, Essen (DE); Stefan Silber, Krefeld (DE); Susanne Struck, Duisburg (DE)

Correspondence Address: FROMMER LAWRENCE & HAUG LLP, 745 Fifth Avenue, New York, NY, 10151, US

(21) Appl. No.: 10/413,116

(22) Filed: Apr. 14, 2003

(30) Foreign Application Priority Data
Apr. 16, 2002 (EP) 02008544.5

(51) Int. Cl. C03C 17/00; C09D 5/00

(52) U.S. Cl. 523/160; 523/161

(57) ABSTRACT

This invention provides for, inter alia, coatings, printing inks or paint varnishes that are curable cationically by radiation and to methods for improving the slip and release properties or the leveling and wetting properties of a coating. The coatings, printing inks or paint vanishes provided for herein comprise at lest one epoxypolysiloxane that is modified with an oxyalkylene group and contains, attached to a Si atom, at least one group of the formula:

—R³—O—(CₙH₍₂ₙ₋ₘ₎R⁴ₘO—)ₓR⁵ (I)

where the variables and indices are described herein.

### RELATED APPLICATIONS

This application claims priority to EP application 020085445, filed Apr. 16, 2002, herein incorporated by reference.

### BACKGROUND OF THE INVENTION

1. Field of the Invention

The invention relates to the use of epoxypolysiloxanes modified with oxyalkylene ether groups as additives for cationically radiation-curing coatings.

2. Description of the Related Art

The epoxypolysiloxanes modified with oxyalkylene ether groups possess excellent properties as additives in cationically radiation-curing coatings, especially printing inks and print varnishes. The epoxypolysiloxanes modified with oxyalkylene ether groups promote the leveling and the wetting properties of the still-liquid coatings, printing inks and/or print varnishes. The cured coatings, printing inks and/or print varnishes possess not only good release properties but also an improved scratch resistance and enhanced gliding properties.

Radiation curing by UV light or electron beams is a rapid, efficient, and environmentally friendly way to cure polymerizable monomers or oligomers. Absence of emissions, low capital costs, and low energy requirement as a result of short drying units, high production rates by virtue of rapid curing, and in many cases a better coating quality, especially in terms of gloss and abrasion resistance, are reasons why radiation curing is the most expansive form of application within the field of industrial coatings.

Radiation-curing coatings, printing inks and/or print varnishes are known and are described, for example, in “UV & EB Curing Formulations for Printing Inks, Coatings & Paints” (R. Holman, P. Oldring, London 1988) or in the brochure “CYRACURE Cycloaliphatic Epoxides, Cationic UV Cure” (The Dow Chemical Company, Midland, Mich., USA).

In contrast to the free-radically radiation-curing coatings, printing inks and/or print varnishes, which frequently exhibit an excessively quick cure and a high level of contraction and, as a result, possess low adhesion, cationically radiation-curing coatings, printing inks and/or print varnishes cure more slowly, and on curing exhibit a low level of shrinkage and a good initial adhesion. In addition, the curing operation is not inhibited by atmospheric oxygen.

Consequently, cationically radiation-curing coatings, printing inks and/or print varnishes are used preferably for the coating of high-grade metal surfaces, for the printing of films (e.g., polyethylene, polypropylene or polyester films), and for coating flexible substrates (e.g., tubes, cups, etc.).

In industrial production, the handling of such high-grade products often causes difficulties. For instance, following the radiation-induced cure of the coating, printing ink and/or print varnish, it is not always possible to rule out damage to the products caused by stacking or other types of manual loading.

In the case of the production of printed packaging materials, moreover, a rapid release effect of the printing ink is desirable, so that labels or coats applied just a short time after the printing operation can be removed again at a later point in time without damage to the printed image.

There are processes known to improve the handlability of freshly printed articles by addition of friction-reducing additives such as oils or waxes (e.g., polyethylene or polytetrafluoroethylene waxes) to the printing ink and/or print varnish. In many cases, however, this leads to a disruptive loss of gloss. The subsequent application of wax to the printed product is also unable to satisfy in every case, especially since this additional process step increases the manufacturing costs. Additionally, high concentrations are required in order to obtain an improvement in scratch resistance. A significant release effect is not achieved in this way.

Furthermore, silicone oils or other organically modified siloxanes, such as polyethersiloxanes, are utilized for this purpose. Silicone products of this kind not only improve the slip and release properties of the cured coating, printing ink and/or print varnish but also improve leveling and wetting properties of the still-liquid materials.

In the course of cationic curing, however, simple silicone oils are not incorporated covalently into the film. If the silicone additives are not chemically incorporated, they may migrate to the surface of the coating over time on account of their incompatibility. In subsequent printing operations, the silicone may go into places where it has a disruptive effect. In stacking operations, in particular, the transfer of the silicone additive to the reverse face of the overlying printed product cannot be ruled out.

Furthermore, and particularly in the food industry, it is important to minimize the fraction of migratable constituents in the coating, so that there can be no migration of the silicone additive into the food product.

Use is also made of simple carbonyl-functional siloxanes, such as polyethersiloxanes. It is known, however, that alcohols act as chain transfer agents (for example: J. V. Crivello, S. Liu, Journal of Polymer Science: Part A: Polymer Chemistry, Vol. 38, 389-401, 2000). They lower the molecular weight of the growing polymer chains and so reduce the through-curing of the cationically radiation-curable coating, printing ink and/or print varnish. Purely carbonyl-functional siloxanes do not exhibit active curing in a cationic radiation cure, but can only act as chain transfer agents (Scheme 1).

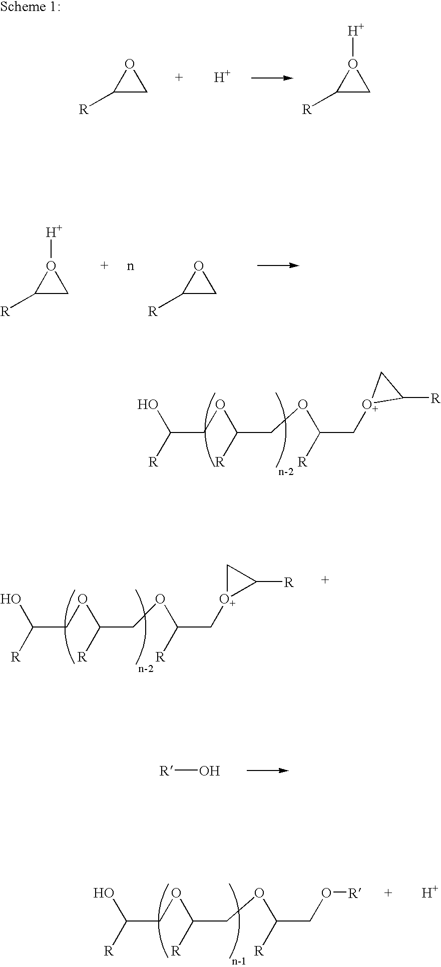

The absence of active cationic curing is a problem with heterogeneous systems in particular. Where the carbonyl-functional siloxane is present in a separate phase, in droplet form in the monomer system, there is no curing and the carbonylfunctional siloxane is able to migrate freely in the coating.

### OBJECTS OF THE INVENTION

It is an object of the present invention to provide organically modified siloxanes which exhibit active cationic curing, improve the leveling and wetting properties of liquid, cationically radiation-curable coatings, printing inks and/or print varnishes, and have a beneficial effect on the slip and release properties of the cationically radiation-cured coatings, printing inks and/or print varnishes.

### SUMMARY OF THE INVENTION

Surprisingly, it has now been found that these and other objects are achieved through the use of epoxypolysiloxanes which are modified with oxyalkylene ether groups and contain at least one oxyalkylene ether group attached to an Si atom of the epoxypolysiloxane as additives in cationically radiation-curing coatings, printing inks and/or print varnishes.

### DETAILED DESCRIPTION OF THE INVENTION

The invention accordingly provides firstly for the use of epoxypolysiloxanes which are modified with oxyalkylene ether groups and contain, attached to an Si atom of the epoxypolysiloxane, at least one group of the general formula (I)

—R³—O—(CₙH₍₂ₙ₋ₘ₎R⁴ₘO—)ₓR⁵ (I)

in which

R³ is a divalent, unsubstituted or substituted alkyl or alkylene radical preferably having 2 to 11 carbon atoms,

n is 2 to 8,

to m is 0 to 2n,

x has a value of 1 to 200, and

R⁴ stands for identical or different alkyl radicals preferably having 1 to 20 carbon atoms or for identical or different, unsubstituted or substituted phenyl radicals having up to 20 carbon atoms,

R⁵ is a hydrogen, an unsubstituted or substituted alkyl radical preferably having 1 to 6 carbon atoms, an acyl radical or a radical —O—CO—NH—R⁶, in which

R⁶ is an unsubstituted or substituted alkyl or aryl radical,

it being possible for the oxyalkylene segments —(CₙH₍₂ₙ₋ₘ₎R⁴ₘO—) within one oxyalkylene ether radical to be different from one another and for the sequence of the individual oxyalkylene segments —(CₙH₍₂ₙ₋ₘ₎R⁴ₘO—) to be arbitrary, embracing in particular block copolymers, random polymers, and combinations thereof, as additives to cationically radiation-curing coatings, printing inks and/or print varnishes.

The invention further provides that, as epoxysiloxanes modified with oxyalkylene ether groups, compounds of the general formula (Ia)

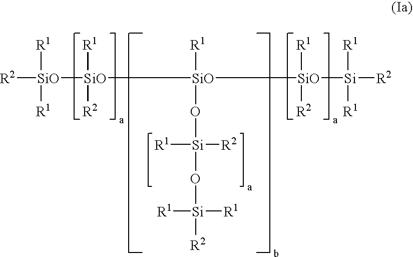

in which

R¹ is identical or different in the molecule and denotes alkyl radicals preferably having 1 to 4 carbon atoms,

R² is defined as follows:

a) alkyl radicals, preferably having 1 to 20 carbon atoms, aryl or aralkyl radicals,

b) epoxy radicals linked via SiC bonds to Si atoms of the polysiloxane,

c) oxyalkylene ether radicals of the general formula (I)

—R³—O—(CₙH₍₂ₙ₋ₘ₎R⁴ₘO—)ₓR⁵

in which

R³ is a divalent, unsubstituted or substituted alkyl or alkylene radical, preferably having 2 to 11 carbon atoms,

n is 2 to 8,

m is 0 to 2n,

x has a value of 1 to 200, and

R⁴ stands for identical or different alkyl radicals, preferably having 1 to 20 carbon atoms or for identical or different, unsubstituted or substituted phenyl radicals, preferably having up to 20 carbon atoms,

R⁵ is a hydrogen, an unsubstituted or substituted alkyl radical, preferably having 1 to 6 carbon atoms, an acyl radical or a radical —O—CO—NH—R⁶, in which

R⁶ is an unsubstituted or substituted alkyl or aryl radical,

it being possible for the oxyalkylene segments —(CₙH₍₂ₙ₋ₘ₎R⁴ₘO—) within one oxyalkylene ether radical to be different from one another and for the sequence of the individual oxyalkylene segments —(CₙH₍₂ₙ₋ₘ₎R⁴ₘO—) to be arbitrary, embracing in particular block copolymers, random polymers, and combinations thereof,

a has a value of 1 to 1000 and

b has a value of 0 to 10,

with the proviso that in the average organopolysiloxane molecule at least one radical R² has the definition b) and at least one radical R² has the definition c),

as additives to cationically radiation-curing coatings, printing inks and/or print varnishes.

The invention further provides that in the formula (I) R³ is an alkyl radical having 2 to 6 carbon atoms, R⁴ is a methyl, ethyl or phenyl radical, m is 0 or 1, and x is 1 to 50.

The invention further provides that R¹ in the formula (Ia) denotes methyl radicals and a has a value of 1 to 500, b has a value of 0 to 10, and x has a value of 1 to 100.

The invention further provides that the additives of the formulae (I) and (Ia) are used in concentrations of from about 0.01 to about 10% by weight, based on total formulations.

The invention further provides that the additives of the formulae (I) and (Ia) are used in mixtures comprising curable compounds which contain epoxy, oxirane and/or vinyl ether groups, especially organopolysiloxanes which contain epoxy, oxirane and/or vinyl ether groups that are free from the group of the general formula (I), as additives to cationically radiation-curing coatings, printing inks and/or print varnishes.

Examples of the radical R¹ are alkyl radicals having 1 to 4 carbon atoms, such as methyl, ethyl, propyl and/or butyl radicals. Methyl radicals are particularly preferred.

Examples of the radical R² are:

a) Alkyl radicals having 1 to 20 carbon atoms, aryl or aralkyl radicals. Examples of alkyl radicals are the methyl, ethyl, propyl, butyl, hexyl, octyl, decyl, dodecyl, hexadecyl or octadecyl radical. A particularly suitable aryl radical is the phenyl radical and a particularly suitable aralkyl radical is the benzyl or phenethyl radical. Particular preference is given to methyl and phenyl radicals.

b) Epoxy radicals, the epoxy radical being linked via an Si—C bond to an Si atom of the polysiloxane. The epoxy radicals contain at least one polymerizable group of the general formula (II)

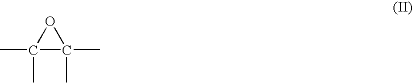

and include the following examples:

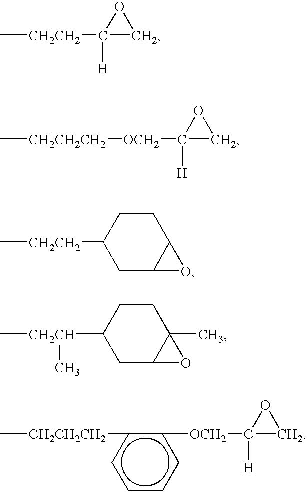

Particular preference is given to the epoxy radicals

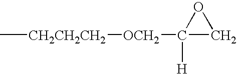

and

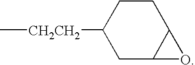

c) Oxyalkylene ether radicals of the general formula (I)

—R³—O—(CₙH₍₂ₙ₋ₘ₎R⁴ₘO—)ₓR⁵

where the radicals R³, R⁴ and R⁵ and also the indices m, n, and x are as defined above.

Examples of such radicals R² are:

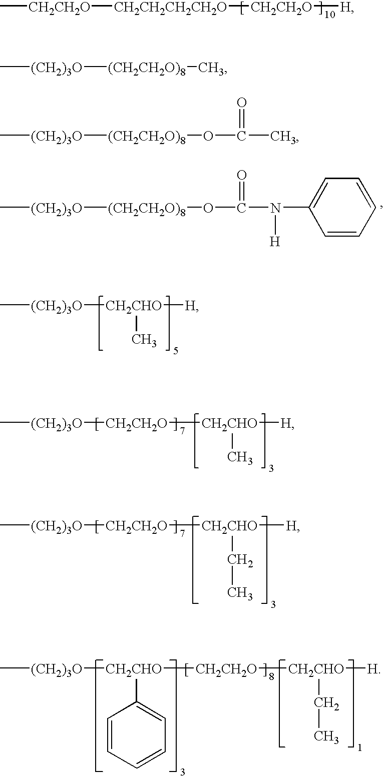

Examples of the radical R⁴ are identical or different alkyl radicals having 1 to 20 carbon atoms, such as the methyl, ethyl, propyl, isopropyl, butyl, isobutyl, hexyl, decyl, dodecyl, hexadecyl or octadecyl radical, or unsubstituted or substituted phenyl radicals having up to 20 carbon atoms, such as the phenyl or tolyl radical.

Particular preference is given to the-methyl and ethyl radicals and to the phenyl radical.

Examples of radical R⁵ are hydrogen, an unsubstituted or substituted alkyl radical having 1 to 6 carbon atoms, such as the methyl, ethyl, propyl, isopropyl, butyl, isobutyl, hexyl or isohexyl radical, or an acyl radical such as the formyl, acetyl, propionyl, butyryl, isobutyryl, valeryl, isovaleryl, pivaloyl, palmitoyl, stearoyl, icosanoyl, acryloyl or methacryloyl radical.

Particular preference is given to alkyl radicals, such as the methyl radical, and acyl radicals, such as the acetyl, acryloyl, and methacryloyl radical.

Examples of R⁶ as an unsubstituted or substituted alkyl or aryl radical are alkyl radicals, such as the methyl, ethyl, propyl, isopropyl, butyl, isobutyl, hexyl, isohexyl, decyl or octadecyl radical, and aryl radicals, such as the phenyl or tolyl radical.

In one preferred embodiment of the present invention the epoxypolysiloxanes modified with oxyalkylene ether groups are those wherein

a has a value of 1 to 500, in particular 1 to 250,

b has a value of 0 to 10, in particular 0 to 5,

x has a value of 1 to 100, in particular 1 to 50.

Examples of epoxypolysiloxanes for use in accordance with the invention that are modified with oxyalkylene ether groups are shown in the following formulae:

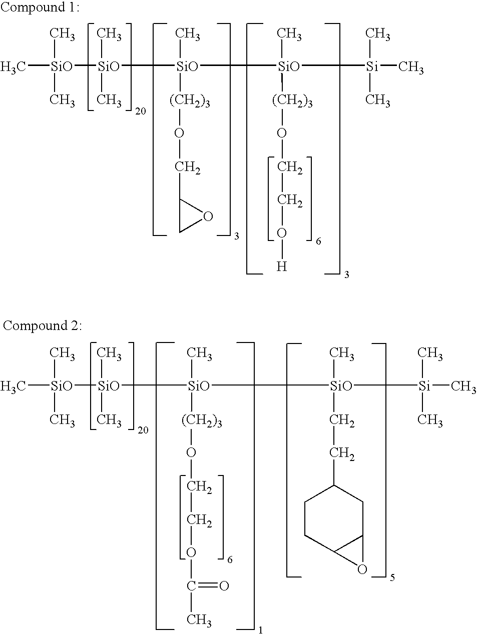

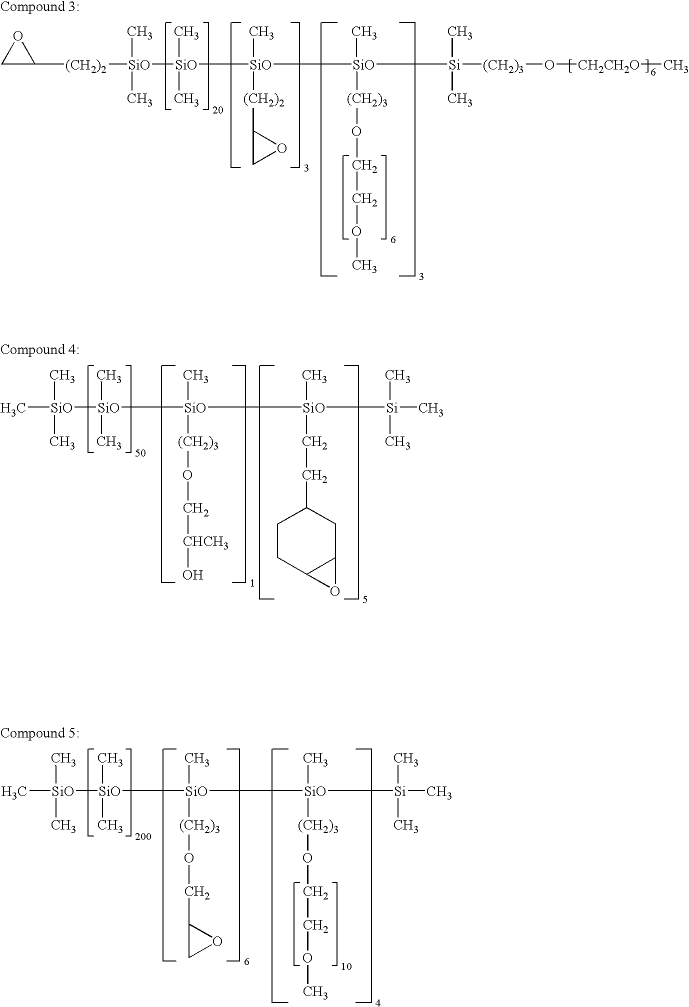

The preparation of epoxysiloxanes modified with oxyalkylene ether groups is described in EP-A-0 468 270. EP-A-0 468 270 also describes the use of epoxysiloxanes modified with oxyalkylene ether groups as radiation-curable coating compositions for release coatings. Such release coatings are used, for example, in adhesive tapes, where a backing tape is coated with a pressure-sensitive adhesive and on its other surface is coated with a release coating having abhesive properties. The abhesive property of the release coating is necessary here in order to prevent permanent bonding of the roll of adhesive tape and to ensure easy unwind of the adhesive tape.

Cationically radiation-curing coatings, printing inks and/or print varnishes are known and are described, for example, in “UV & EB Curing Formulations for Printing Inks, Coatings & Paints” (R. Holman, P. Oldring, London 1988) or in the brochure “CYRACURE Cycloaliphatic Epoxides, Cationic UV Cure” (The Dow Chemical Company, Midland, Mich., USA).

The epoxysiloxanes of the invention modified with oxyalkylene ether groups may be present within radiation-curing coatings, printing inks and/or print varnishes in a concentration of from about 0.01 to about 10.0% by weight, preferably from about 0.5 to about 2% by weight.

Where appropriate, they may be used in mixtures with curable compounds containing epoxy, oxirane and/or vinyl ether groups, especially organopolysiloxanes which contain epoxy, oxirane and/or vinyl ether groups that are free from the group of the general formula (I), and/or as a mixture with polysiloxanes containing oxyalkylene ether groups, as additives to cationically radiation-curing coatings, printing inks and/or print varnishes.

The fractions of these components should be minimized, and these mixtures are not preferred in accordance with the invention.

The nature of the group R² exerts a direct influence on the compatibility of the epoxysiloxanes modified with oxyalkylene ether groups with the coating, printing ink and/or print varnish.

### EXAMPLES

The invention is illustrated below with reference to examples. The inventive compounds 1 to 5 and the following noninventive comparative examples 1 to 3 are used for this purpose.

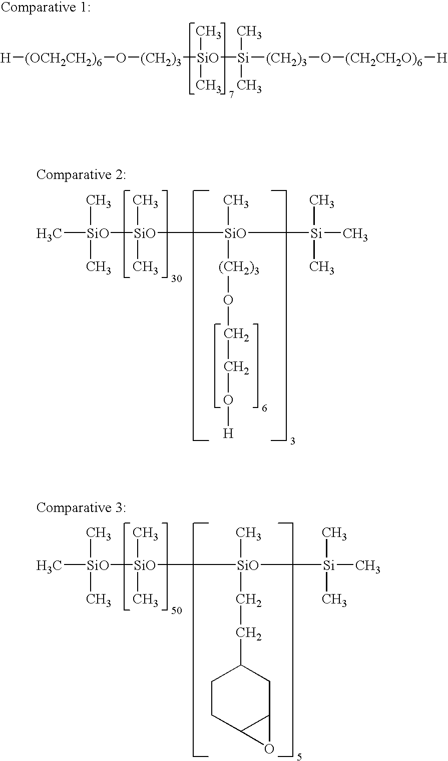

To investigate the active curing of the silicone additives (compounds 1 to 5 and comparatives 1 to 3) the silicone additives were admixed with 5% by weight of CYRACURE® photoinitiator UVI-6990 and knifecoated onto Leneta® sheets in a wet thickness of 12 μm. Curing was effected by exposure to UV light at 120 W/cm with a belt speed of 3 m/min. This operation was repeated twice in each case. The surface was then assessed for its curing. The results are summarized in Table 1.

TABLE 1

| Compound | Curing |
|---|---|
| Compound 1 | Cured |
| Compound 2 | Cured |
| Compound 3 | Cured |
| Compound 4 | Cured |
| Compound 5 | Cured |
| Comparative 1 | Liquid |
| Comparative 2 | Liquid |
| Comparative 3 | Cured |

It is evident that only the epoxy-functional siloxanes exhibit an active cationic cure. Purely carbonyl-functional siloxanes (comparatives 1 and 2) do not display any active cationic curing.

To investigate the performance properties, the following coating and printing ink formulations were selected from the brochure “CYRACURE Cycloaliphatic Epoxides, Cationic UV Cure” (The Dow Chemical Company, Midland, Mich., USA).

Formulation 1:

70.9 g CYRACURE® cycloaliphatic epoxide UVR-6110

24.6 g TONE® polyol 0301

6.0 g CYRACURE® photoinitiator UVI-6990

0.5 g silicone additive

Formulation 2:

81.2 g CYRACURE® cycloaliphatic epoxide UVR-6110

10.1 g Lithol® Rubine D4569 from BASF

7.3 g CYRACURE® photoinitiator UVI-6990

0.5 g silicone additive

The coatings, printing inks and/or print varnishes were formulated conventionally in accordance with the above formulations. The last ingredient added in each case was the silicone additive.

To determine the foaming of the silicone additives in the liquid coatings, printing inks and/or print varnishes, 50 g in each case of the liquid formulation (formulation 1) were placed in a 100 ml glass and stirred using an Ultraturrax at 4000 rpm for 3 minutes. Thereafter, the height of foam was reported as the difference from the level of the liquid in the case of the unstirred formulation.

To determine the performance properties of the cured coatings (formulation 1), the formulations were applied to Leneta® sheets in a wet film thickness of 12 μm using an applicator. Curing was effected by exposure to UV light at 120 W/cm with a belt speed of 10 m/min. This operation was repeated twice in each case.

Thereafter, the leveling was assessed visually. The assessment was made using a scale from 1 to 4, where 1 describes a defect-free film while 4 testifies to severe leveling defects.

The slip value of the cured coating was determined using a specially converted electrically driven film drawdown apparatus with a constant rate of advance. On the movable doctor-blade mount, instead of the film-drawing doctor blade inserted, a plate was mounted which lies on rollers at the other end of the apparatus. By means of the doctor-blade mount it was possible to move the plate, to which the coated Leneta® sheet was fastened. To determine the slip value, a weight (200 g) with a flat felt underlay was placed on the coated sheet. The coated sheet on the plate was pulled away below the weight at a speed of 11 mm/s. The vertical force required for this purpose was measured by means of a force transducer and is termed the slip value. The wetting properties were determined by examining the above-described films for wetting defects. Assessment was made using a scale from 1 to 4, where 1 describes a defect-free film while 4 testifies to severe wetting defects.

The release properties of the cured coatings were characterized by determining what is called the release value. The release values were determined using adhesive tapes with a width of 25 mm from Beiersdorf, which are available commercially under the name TESA® 4154. To measure the release values, the adhesive tapes were applied to the cured coating using rollers and then stored at 40° C. under a weight of 70 g/cm². After 24 hours a measurement was made of the force required to peel each adhesive tape from the substrate at an angle of 180° and a speed of 6 mm/s. This force is termed the release value. The general test procedure corresponds essentially to the FINAT (Fédération Internationale des Fabricants et Transformateurs d'Adhésifs et Thermocollantes sur Papiers et autres Supports) test method No. 10. The results are summarized in Table 2.

TABLE 2

| | Foam | | | | |
|---|---|---|---|---|---|
| | height/ | Level- | Slip | Wetting | Release |
| Formulation 1 | mm | ing | value/cN | properties | value/cN/cm |
| No additive | 5 | 4 | 464 | 4 | 418 |
| Compound 1 | 7 | 2.5 | 365 | 2 | 274 |
| Compound 2 | 6 | 2 | 326 | 1.5 | 214 |
| Compound 3 | 6.5 | 2.5 | 402 | 2 | 262 |
| Compound 4 | 3 | 3 | 75 | 3.5 | 106.8 |
| Compound 5 | 3 | 4 | 54 | 4 | 65 |
| Comparative 1 | 7 | 2.5 | 432 | 2.5 | 332 |
| Comparative 3 | 3 | 4 | 53 | 4 | 45 |
| Comparative 2 | 9 | 2 | 64 | 2 | 189 |

To determine the foaming of the silicone additives during screen printing, the cationically radiation-curable printing ink (formulation 2) was screenprinted onto polyester film. After radiation curing, the screen print was assessed visually. The assessment was made using a scale from 1 to 4, where 1 describes a defect-free print while 4 testifies to severe defects. The results are summarized in Table 3.

TABLE 3

| Compound | Printed image |
|---|---|
| No additive | 3 |
| Compound 1 | 2 |
| Compound 2 | 1.5 |
| Compound 3 | 2 |
| Compound 4 | 2.5 |
| Compound 5 | 3 |
| Comparative 1 | 2.5 |
| Comparative 2 | 2 |
| Comparative 3 | 3.5 |

As is apparent from Tables 1, 2 and 3 above, the epoxysiloxanes of the invention modified with oxyalkylene ether groups are notable for their universal applicability. As is evident from the comparative examples, the nature of the group R is critical for the epoxysiloxanes modified with oxyalkylene ether groups, for use in accordance with the invention, to display active cationic curing, to improve the leveling and wetting properties of liquid, cationically radiation-curable coatings, printing inks and/or print varnishes, and to have beneficial effects on the slip and release properties of the cationically radiation-cured coatings, printing inks and/or print varnishes.

At the same time, the epoxysiloxanes modified with oxyalkylene ether groups, for use in accordance with the invention, exhibit a lower foam-stabilizing effect.

The above description of the invention is intended to be illustrative and not limiting. Various changes or modification in the embodiments described herein may occur to those skilled in the art. These changes can be made without departing from the scope or spirit of the invention.

What is claimed is:

1. A coating, printing ink or paint varnish that is curable cationically by radiation, which comprises a compound that contains epoxy, oxirane and/or vinyl groups and an additive comprising at least one epoxypolysiloxane which is modified with oxyalkylene ether groups and contains attached to an Si atom of the epoxypolysiloxane, at least one group of the formula
—R³—O—(CₙH₍₂ₙ₋ₘ₎R⁴ₘO—)ₓR⁵ (I)
in which
R³ is a divalent, unsubstituted or substituted alkyl or alkylene radical,
n is 2 to 8,
m is 0 to 2n,
x has a value of 1 to 200, and
R⁴ stands for identical or different alkyl radicals having or for identical or different, unsubstituted or substituted phenyl radicals,
R⁵ is a hydrogen, an unsubstituted or substituted alkyl radical, an acyl radical or a radical —O—CO—NH—R⁶, in which
R⁶ is an unsubstituted or substituted alkyl or aryl radical,
it being possible for the oxyalkylene segments —(CₙH₍₂ₙ₋ₘ₎R⁴ₘO—) within one oxyalkylene ether radical to be different from one another and for the sequence of the individual oxyalkylene segments —(CₙH₍₂ₙ₋ₘ₎R⁴ₘO—) to be arbitrary, random polymers, or combinations thereof.

2. The coating, printing ink or paint varnish according to claim 1, wherein the epoxysiloxanes are compounds of the general formula (Ia) 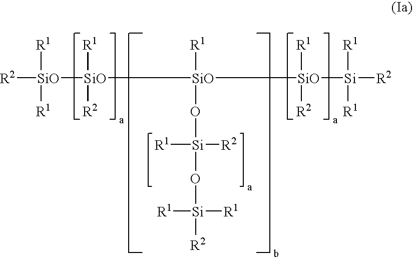
in which
R¹ is identical or different in the molecule and denotes alkyl,
R² is defined as follows:
a) alkyl radicals, aryl or aralkyl radicals,
b) epoxy radicals linked via SiC bonds to Si atoms of the polysiloxane,
c) oxyalkylene ether radicals of the general formula (I)
—R³—O—(CₙH₍₂ₙ₋ₘ₎R⁴ₘO—)ₓR⁵
in which
R³ is a divalent, unsubstituted or substituted alkyl or alkylene radical,
n is 2 to 8,
m is 0 to 2n,
x has a value of 1 to 200, and
R⁴ stands for identical or different alkyl radicals or for identical or different, unsubstituted or substituted phenyl radicals,
R⁵ is a hydrogen, an unsubstituted or substituted alkyl radical, an acyl radical or a radical —O—CO—NH—R⁶, in which
R⁶ is an unsubstituted or substituted alkyl or aryl radical,
it being possible for the oxyalkylene segments —(CₙH₍₂ₙ₋ₘ₎R⁴ₘO—) within one oxyalkylene ether radical to be different from one another and for the sequence of the individual oxyalkylene segments —(CₙH₍₂ₙ₋ₘ₎R⁴ₘO—) to be arbitrary, random polymers, or combinations thereof,
a has a value of 1 to 1000 and
b has a value of 0 to 10,
with the proviso that in the average organopolysiloxane molecule at least one radical R² has the definition b) and at least one radical R² has the definition c).

3. The coating, printing ink or paint varnish according to claim 1, wherein in the formula (I) R³ is an alkyl radical having 2 to 6 carbon atoms, R⁴ is a methyl, ethyl or phenyl radical, n is 2 to 8, m is 0 or 1, and x is 1 to 50.

4. The coating, printing ink or paint varnish according to claim 1, wherein R¹ in the formula (Ia) denotes methyl radicals and a has a value of 1 to 500, b has a value of 0 to 10, and x has a value of 1 to 100.

5. The coating, printing ink or paint varnish according to claim 1, in concentrations of from about 0.01 to about 10% by weight, based on the total formulation.

6. The coating, printing ink or paint varnish according to claim 1 wherein the epoxypolysiloxane is modified with oxyalkylene ether groups and contains attached to an Si atom of the epoxypolysiloxane, at least one group of the formula
—R³—O—(CₙH₍₂ₙ₋ₘ₎R⁴ₘO—)ₓR⁵ (1)
in which
R³ is a divalent, unsubstituted or substituted alkyl or alkylene radical having 2 to 11 carbon atoms,
n is 2 to 8,
m is 0 to 2n,
x has a value of 1 to 200, and
R⁴ stands for identical or different alkyl radicals having 1 to 20 carbon atoms or for identical or different, unsubstituted or substituted phenyl radicals having up to 20 carbon atoms,
R⁵ is a hydrogen, an unsubstituted or substituted alkyl radical having 1 to 6 carbon atoms, an acyl radical or a radical —O—CO—NH—R⁶, in which
R⁶ is an unsubstituted or substituted alkyl or aryl radical,
it being possible for the oxyalkylene segments —(CₙH₍₂ₙ₋ₘ₎R⁴ₘO—) within one oxyalkylene ether radical to be different from one another and for the sequence of the individual oxyalkylene segments —(CₙH₍₂ₙ₋ₘ₎R⁴ₘO—) to be arbitrary, random polymers, or combinations thereof.

7. The coating, printing ink or paint varnish according to claim 1, wherein the epoxypolysiloxane has at least one epoxy radical selected from the group consisting of: 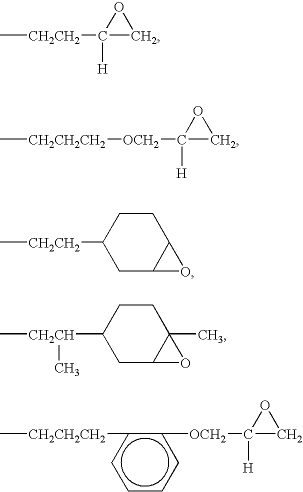
and at least one oxyalkylene ether radical selected from the group consisting of:

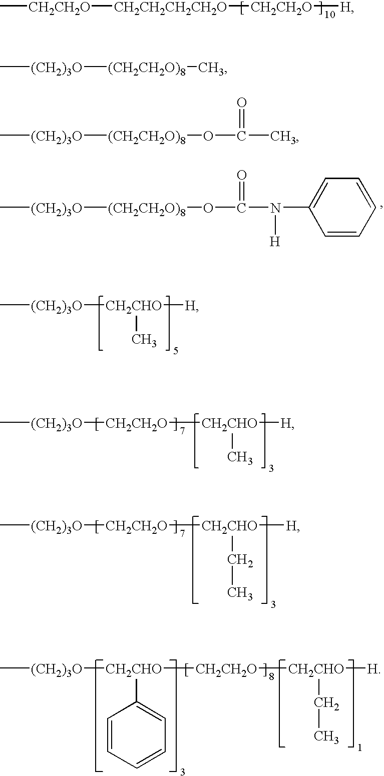

8. The coating, printing ink or paint varnish according to claim 1, wherein the epoxysiloxane is a compound selected from the group consisting of:

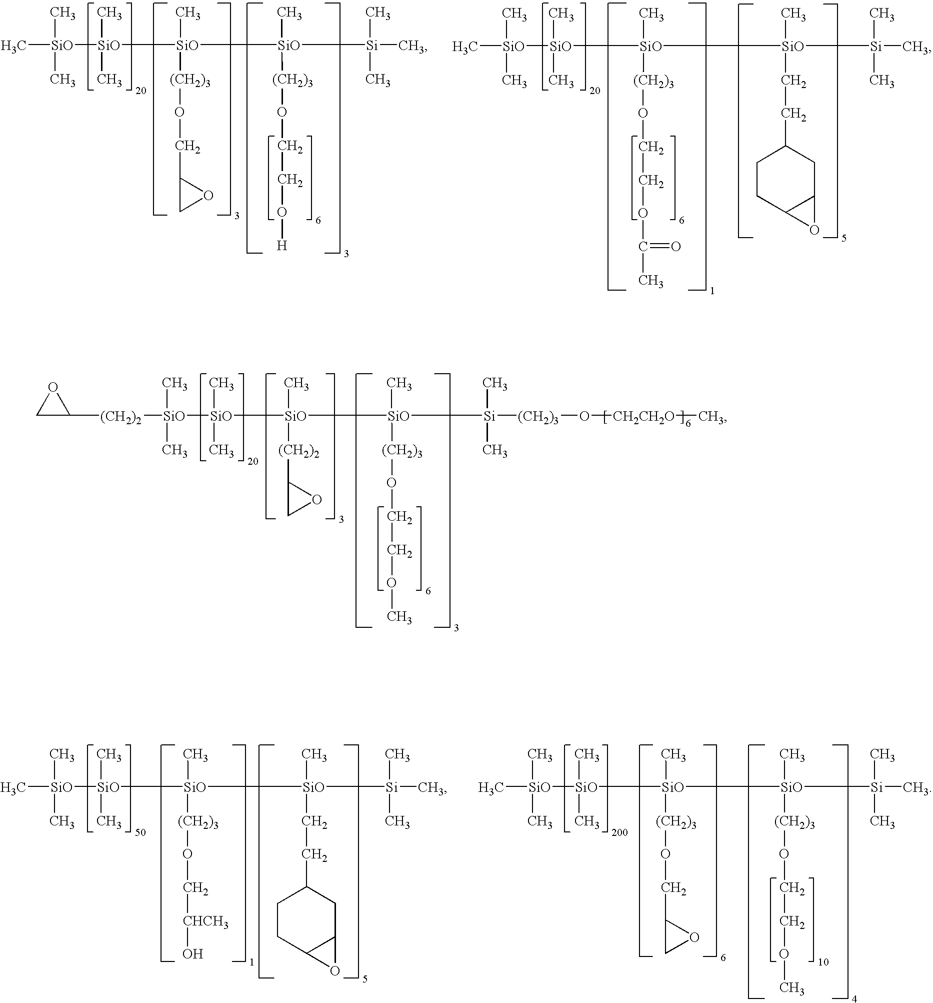

9. A method for improving the slip and release properties of a coating, printing ink or paint varnish, which is cured cationically by radiation, which comprises adding to said coating, printing ink or paint varnish, an additive comprising at least one epoxypolysiloxane, which is modified with an oxyalkylene ether group and contains, attached to an Si atom of the epoxypolysiloxane, at least one group of the formula
—R³—O—(CₙH₍₂ₙ₋ₘ₎R⁴ₘO—)ₓR⁵ (I)
in which
R³ is a divalent, unsubstituted or substituted alkyl or alkylene radical,
n is 2 to 8,
m is 0 to 2n,
x has a value of 1 to 200, and
R⁴ stands for identical or different alkyl radicals having or for identical or different, unsubstituted or substituted phenyl radicals,
R⁵ is a hydrogen, an unsubstituted or substituted alkyl radical, an acyl radical or a radical —O—CO—NH—R⁶, in which
R⁶ is an unsubstituted or substituted alkyl or aryl radical,
it being possible for the oxyalkylene segments —(CₙH₍₂ₙ₋ₘ₎R⁴ₘO—) within one oxyalkylene ether radical to be different from one another and for the sequence of the individual oxyalkylene segments —(CₙH₍₂ₙ₋ₘ₎R⁴ₘO—) to be arbitrary, random polymers, or combinations thereof.

10. A method for improving the leveling and wetting properties of a coating, printing ink or paint varnish, which is cured cationically by radiation, which comprises adding to said coating, printing ink or print varnish, an additive comprising at least one epoxypolysiloxane, which is modified with oxyalkylene ether groups and contains, attached to an Si atom of the epoxypolysiloxane, at least one group of the formula
—R³—O—(CₙH₍₂ₙ₋ₘ₎R⁴ₘO—)ₓR⁵ (I)
in which
R³ is a divalent, unsubstituted or substituted alkyl or alkylene radical,
n is 2 to 8,
m is 0 to 2n,
x has a value of 1 to 200, and
R⁴ stands for identical or different alkyl radicals having or for identical or different, unsubstituted or substituted phenyl radicals,
R⁵ is a hydrogen, an unsubstituted or substituted alkyl radical, an acyl radical or a radical —O—CO—NH—R⁶, in which
R⁶ is an unsubstituted or substituted alkyl or aryl radical,
it being possible for the oxyalkylene segments —(CₙH₍₂ₙ₋ₘ₎R⁴ₘO—) within one oxyalkylene ether radical to be different from one another and for the sequence of the individual oxyalkylene segments —(CₙH₍₂ₙ₋ₘ₎R⁴ₘO—) to be arbitrary, random polymers, or combinations thereof.
